(19) United States
(12) Patent Application Publication
(10) Pub. No.: US 2008/0097768 A1
(43) Pub. Date: Apr. 24, 2008

(54) Visualization of future value predictions and supporting factors for real estate by block

(76) Inventor: Edward L. Godshalk, San Jose, CA (US)

Correspondence Address: Hahn and Moodley LLP, P.O. Box 52050, Minneapolis, MN, 55402, US

(21) Appl. No.: 11/549,089

(22) Filed: Oct. 12, 2006

(51) Int. Cl. G06Q 10/00; G06Q 30/00

(52) U.S. Cl. 705/1

(57) ABSTRACT

Methods and systems for block level visual presentation of real estate forecasts and related statistical confidence indicators and supporting factors. The visual presentations build upon a data set comprising block level future value predictions, statistical confidence indicators and supporting factors. A map of a user selected geographical area is visually marked to distinguish blocks or block groups based on their future value predictions. Additional overlay information includes statistical confidence indicators associated with the future value predictions, as well as presentation of supporting factors representing “reasons” behind the predictions. Visualizations allow user interactions, thereby offering the ability to visually navigate the predictions and supporting factors using tables, graphs and other tools.

### FIELD

Embodiments of the invention relate generally to data visualization, and in particular to the visualization of real estate data.

### BACKGROUND

Real estate analysis involves consideration of geographical areas, demographic trends, value forecasting and a host of other interacting factors. With steadily increasing variations and amounts of such data, the clear and digestible visual presentation of real estate related data represents a useful component of real estate analysis and decision making.

### SUMMARY

Methods and systems are disclosed for block level visual presentation of real estate forecasts and related statistical confidence indicators and supporting factors. The disclosed visual presentation techniques build upon a data set comprising block level future value predictions, statistical confidence indicators and supporting factors. A map of a user selected geographical area is visually marked to distinguish blocks or block groups based on their future value predictions. Additional overlay information includes statistical confidence indicators associated with the future value predictions, as well as presentation of supporting factors representing “reasons” behind the predictions. Visualizations allow user interactions, thereby offering the ability to visually navigate the predictions and supporting factors using tables, graphs and other tools.

### BRIEF DESCRIPTION OF DRAWINGS

FIG. 1 illustrates a collection of block level future value prediction data, in accordance with an embodiment of the present invention.

FIG. 2a illustrates an example map depicting an approximately 1000 ft×1000 ft map of Palo alto, Calif., USA, with geographical areas marked according to their future value predictions for a specific time period, in accordance with an embodiment of the present invention.

FIG. 2b illustrates another example map depicting the region of Tampa Bay, Fla., USA, with geographical areas marked according to their future value predictions for a specific period of time, in accordance with an embodiment of the present invention.

FIG. 3a illustrates a simplified map with the blocks represented by rectangles, for ease of illustration of the techniques presented herein in accordance with embodiments of the present invention.

FIG. 3b illustrates a map markings key for the map shown in FIG. 3a, in accordance with an embodiment of the present invention.

FIG. 4 shows an example presentation of some example future value predictions, along with their respective statistical confidence indicators, in accordance with an embodiment of the present invention.

FIG. 5 illustrates an example presentation of one or more factors supporting the future value prediction of user selected blocks, in accordance with an embodiment of the present invention.

FIGS. 6 and 7 illustrate example presentations of one or more supporting factors, as presented to a user and for the purpose of allowing the user to choose a specific factor as a basis for a re-drawing of a map, in accordance with embodiments of the present invention.

FIG. 8 shows one way of visualizing a future value predictions map along with a set of user selected factors visualized using graphs, in accordance with an embodiment of the present invention.

FIG. 9a illustrates a standalone implementation of a system for visual presentation of real estate data, in accordance with an embodiment of the present invention.

FIG. 9b illustrates a networked implementation of a system for visual presentation of real estate data, in accordance with an embodiment of the present invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Today, real estate forecasting and related visualization techniques generally build upon data collected either at small local levels comprising individual properties or at the level of larger geographical regions such as Metropolitan Statistical Areas (MSAs). For example, the Automatic Valuation Model (AVM) uses mathematical models to predict (or auto appraise) a single real estate property. Such models are currently being used by the Federal national Mortgage Association (Fanny Mae) on some second trusts in order to save on the cost of a standard appraisal. Other models have been developed to predict the future appreciation by MSA, however an MSA is much larger than a block and hence the presentation of such predictions are quite granular.

Furthermore, while real estate agents use their individual knowledge and news sources to best guess the degree of real estate appreciation in a geographical area, for the most part this is centered on the sale of real estate and is not suited for the visual presentation of future value predictions qualified by statistical confidence indicators and supported by underlying factors.

The embodiments of the present invention disclose techniques for visually presenting critical information to segments of the real estate market. For example, in the business-to-business (B2B) segment of the market, real estate agents and Realtors®, multiple listing services (MLS), relocation companies, as well as companies that are expanding geographically may often want to know if a given property will appreciate in value. The embodiments disclosed herein visually present information comprising future value (FV) predictions, accompanied by statistical confidence indicators such as standard deviations for the presented information, as well as supporting factors contributing to the future value predictions.

Predicted future values are visually presented at block level or block group level resolutions, wherein “blocks” represent geographically demarcated areas as defined by the US Census.

Future value predictions are qualified by their distance into the future, such as future value predictions for the next quarter or the next year. Along with the predicted future values, other key variables are presented upon request. Such key variables include micro-economic variables such as block population growth, income growth, crime, quality of life, school quality, cash flow, demand, vacancy rates, affordability, and distances to features at the block level. Other macro-economic variables include interest rates, building permits, national and state gross domestic product (GDP), and monetary policies. These components, presented for a given block or block group, aid the user (hereinafter also referred to as “consumer” of the visually presented information) in gauging the level of trust to place in the predictions.

As an example application, the present embodiments provide real estate businesses and real estate brokerage houses the ability to have their agents become local experts on their geographical real estate markets by having access to prediction data and supporting information in a visually accessible fashion that aids analysis. For instance, by comparing three different areas within one zip code based on user defined criteria such as job growth, future appreciation and cash-flow, real estate agents can better service their clients and be more effective at sales.

As another example, a growing company or organization benefits from a tool for determining where to move to or build. Similarly, real estate developers want to know the markets that are most likely to appreciate, and easy-to-view visual presentations of predictions along with statistical confidence levels and supporting data allow a more calculated placement of trust in the presented predictions.

In the business-to-consumer (B2C) segment of the market, accessible visual presentation of future value predictions provide homeowners and real estate investors the knowledge and tools to make faster and more accurate decisions regarding home or investment purchases. This is underscored by the fact that to date, the available but non-centralized and non-compiled data causes much frustration within the real estate community. For example, an investor from New York may be able to find sufficient information to support a decision to invest in a large geographical area such as Phoenix, Ariz., but near real-time visual presentation tools which can help determine which block to invest in within the larger Phoenix area in area currently not available.

In general, sources of supporting data may include the United States Postal Service (USPS), United States Department of Defense (DMDC), United States Census Bureau, National Center for Education Statistics (NCES), Federal Financial Institutions Examination Council (FFIEC), Internal Revenue Service (IRS), Bureau of Economic Analysis (BEA), Bureau of Labor Statistic (BLS), Office of Federal Housing Enterprise Oversight (OFHEO), National Association of Realtors (NAR), Mortgage Bankers Association (MBA), Dow Jones, Federal Reserve Board, The Conference Board, The American Bankers Association, and any other sources of supporting data.

Key categories of supporting data include income trends and changes, macro and micro demographic changes, micro and macro cyclical factors such as migration, unemployment rates, availability of credit, housing starts, building permits, completed building permits, vacancy rates, stability of growth, expected growth, expected future values, consumer spending patterns, change in number of business establishments and there permits, total crime, change in education levels, property taxes, change in quality of life (including a variety of subset variables), proximity to jobs and features (spatial-temporal analysis), number of recent movers and new homes, weather and earthquake risk, school quality, expected drive times, and median age of dwellings.

The techniques for producing the data set comprising block level or block group level future value predictions, associated statistical confidence indicators and supporting factors are disclosed in co-pending U.S. patent application Ser. No. xx/xxx,xxx, which is incorporated herein by reference.

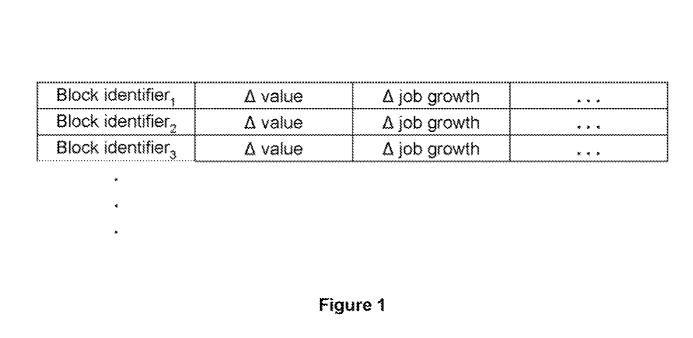

FIG. 1 illustrates a skeleton for such a data set, in accordance with an embodiment of the present invention. A record (row) indicates a specific block, using any suitable block identification system, as well as one or more pieces of data associated with the block. In the example shown in FIG. 1, the blocks are identified by block identifiers, and the associated data include a prediction of the change (represented by the symbol Δ) in the future value of the block, as well as a change in the job growth of the area. The records may include other supporting data, as further disclosed herein.

The categories of data that can be associated with a block are varied and include, by way of example and not limitation, the following:
Race (e.g. percentage white, black, Hispanic, etc.), age and other demographics;
Civilian unemployed vs. employed (to get percentage of employed);
Median household income, net worth, disposable income, income expenses, number of employees, housing cost or income, and housing equity;
Percentage expenses per consumer items;
Units that are vacant, owner occupied, non-owner occupied, renter occupied, etc., in order to get vacancy rates and occupancy demand;
Median property value (of home);
Total establishments/businesses, new businesses, Standard Industry Classification (SIC) codes;
Crime index;
Average drive times;
Quality of life (a combination of a variety of other variables);
Population, education, recent movers, migration, growth patterns of family size, number of children, average age, first movers, divorce rates, marriages, growth of housing demand;
Home age, square feet, number of bedrooms and baths;
Building permits, business permits, available buildable land, local tax and business environment;
Interest rates;
National, state, and MSA GDP, personal income, and housing inventory;
Housing Median value, average value, price of substitutes;
Spatial temporal data: proximity to features, employment centers, conveyances, key demand areas;
Cost of features: utilities, permits, community planning, zoning, amenities, local taxes, expected and growth potential of cash flow (median value compared to median rent); and
Features, including a variety of subset items such as schools and quality of schools.

### Other categories include ethnicity, ancestry, education levels, age, sex, political preference, occupation types, languages spoken, transportation methods, transportation costs, expenses on consumer goods, types of businesses, and present home values.

For each of the above variables, the visual presentations described below may further use a variety of derived variables, including but not limited to:
Change in last quarter to next quarter, shown as a percentage change;
Change in the variable as compared to the average change over last four quarters (last year);
Change in the percentage change by block group as compared to the percentage change by zip code;
Change in the percentage change by block group as compared to the percentage change by county;
Change in the percentage change by block group as compared to the percentage change by state.

### As should be obvious to one of ordinary skill in the art, other similar derived variables are possible by comparing other geographical units and time windows.

### Visual Presentation of Future Value Predictions

Having described the various sets of data, we now turn to describing how such data is presented visually, in accordance with embodiments of the present invention. The primary visual canvas upon which the data set (or relevant portions thereof) is visualized is a map of a chosen geographical area. The map may be of a large geographical area such as the entire United States or a particular state, or on a small zip code or street-level scale, or on any other scale chosen by the user. In either case, the underlying subdivision of the presented geographical area on the map is by block or block groups.

Blocks or block groups on the map are visually marked based on the future value predictions represented in the data set being used, wherein a future value prediction is represented as a blocks' or block groups' expected value for the next quarter (or other future period, according to the underlying data set). As described above, a future value prediction may be accompanied by a visualization of an associated confidence indicator, as described in more detail below, in order to serve as an aid for determining the amount of trust a user can place in the respective predictions.

As a concrete example, the data set may indicate that a specific block has an expected value change of 3.5% for the next quarter (as compared over the previous quarter) with a statistical confidence of 95%. This means that the underlying data set is indicating a 3.5% appreciation with a 95% confidence, according to whatever the particular definition of confidence happens to be in the data set. On the visually presented map, the block is then marked accordingly.

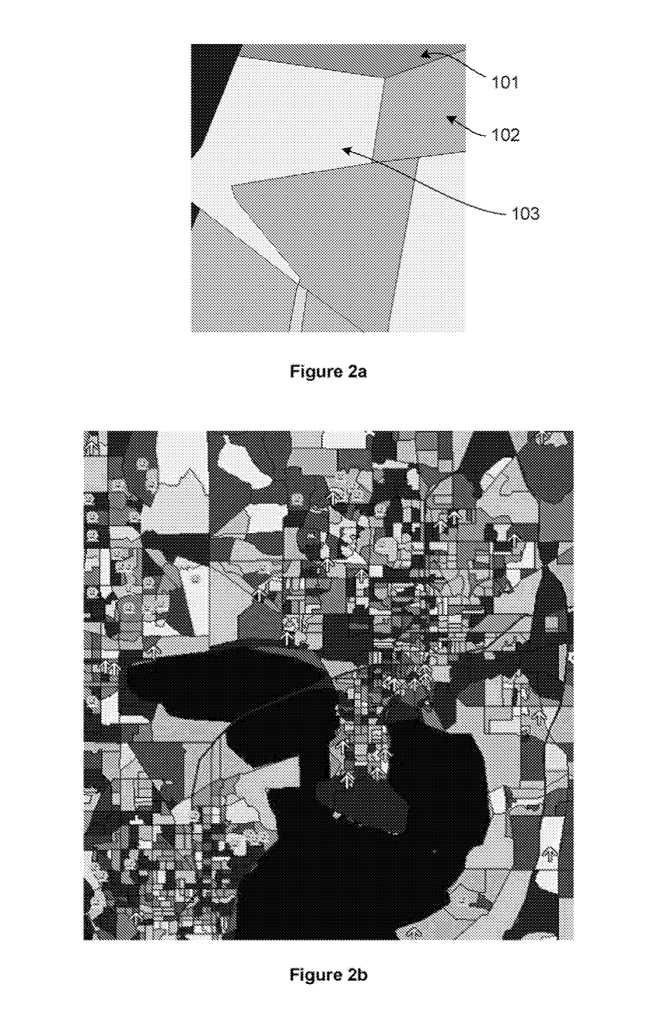

For example, FIG. 2a illustrates an example map depicting an approximately 1000 ft×100 ft area of Palo Alto, Calif. USA, with geographical areas marked according to their future value predictions for a specific time period, in accordance with an embodiment of the present invention. Example blocks 101, 102 and 103 are shown and visually marked according to their future value predictions.

FIG. 2b illustrates another example map depicting a region of Tampa Bay, Fla., USA, with geographical areas marked according to their future value predictions for a specific period of time, in accordance with an embodiment of the present invention. FIG. 2b shows a larger geographic area comprising a large number of block groups than the area shown in FIG. 2a. Both maps in FIGS. 2a and 2b are grayscale reproductions of colored maps produced by an implementation of an embodiment of the present invention, as it should be obvious that colored maps are easier to digest visually and more easily convey information to humans.

The markings of the map areas (blocks or block groups) are according to a markings key describing the correspondence between data levels and visual markings. For example, if the markings are color based, the markings key associates color gradients with numerical ranges for the future value predictions. As another example, if the markings are chosen from a set of other visually distinct markings, such a set of black and white or gray scale patterns, then the markings key establishes an association between the elements of the pattern set and the future value prediction ranges.

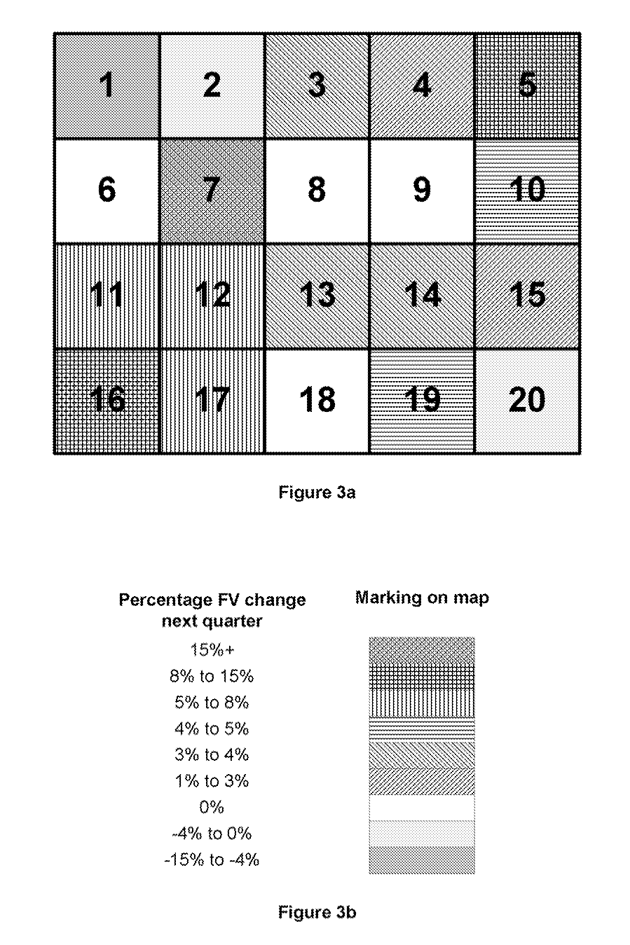

For ease and conciseness of illustration in the remainder of the present description, we consider a representative map in which the blocks are represented by simple rectangles. Such a simplified map is shown in FIG. 3a, with the corresponding markings key shown in FIG. 3b, in accordance with an embodiment of the present invention. Table 1 shows a set of example data for the blocks shown in the map of FIG. 3a.

TABLE 1

| Grid | Color on map | Meaning | % value change | Block Group |
|---|---|---|---|---|
| 7, 5, 16 | (see FIG. 3b) | Highest FV | 15% + next quarter | 060816112001 |
| | (see FIG. 3b) | High FV | 8%~15% change | 060816112002 |
| | | | | 060816118001 |
| 11, 12, 17 | (see FIG. 3b) | Median High FV | 5%~8% change | 060816119001 |
| | | | | 060816118013 |
| | | | | 060816119001 |
| 10, 19 | (see FIG. 3b) | Median | 4%~5% change | 060816119005 |
| | | | | 060816119004 |
| 3, 13, 14 | (see FIG. 3b) | Average | 3%~4% change | 060816119003 |
| | | | | 060816119002 |
| | | | | 060816119006 |
| 4, 15 | (see FIG. 3b) | Below Average | 1%~3% change | 060816121002 |
| | | | | 060855111004 |
| 6, 8, 9, 18 | (see FIG. 3b) | Neutral | 0% change | 060855111001 |
| | | | | 060855111005 |
| | | | | 060855111004 |
| | | | | 060855111009 |
| 2, 20 | (see FIG. 3b) | Poor | 0%~4% change | 060855111003 |
| | | | | 060855111002 |
| 1 | (see FIG. 3b) | Time to sell | ~4% to ~15% change | 060816121004 |
| | | | | 060816121006 |

In one embodiment, the presented maps may be zoom-able. Advantageously, this enables the user to benefit from interaction with the visual presentations disclosed here. With a zoom-able map that is gradient color-coded according to the future value predictions, a user can easily distinguish by color (or alternatively by any other visual markings used) the highest appreciating subsections of a user selected geographical market.

A map may further comprise an overlay of features which the consumer cares about. The depiction of such features may be customizable, such as via a choice of the particular set of characters and/or symbols designating the various features of interest. For example, a prominent (e.g. bold or large) “↑” may represent a high-demand or less-than-1% vacancy rate within the associated block or block group, while a less prominent (e.g. non-bold or small) “↑” may represent a 3% vacancy rate and a ↓ may represent higher vacancy rates (as defined or customized by the user). As another example, a “Δ” may represent the presence of substantial changes in one or more factors over the last quarter or other period. Other symbols may include [symbol] etc., depicting various conditions or flags to the user. The symbols may optionally be gradient colorized or otherwise visually enhanced in order to convey more information. Symbols and other visual markings may be placed at specific longitude and latitude coordinates associated with the information being conveyed by the markings.

### Choosing a Geographical Area for Visual Presentation

For the visual presentations, a user may select the geographical area of interest in any number of ways, such as by providing an address (one or more of Street, City, State, zip code), a set of longitude and latitude coordinates, or simply by starting with a geographical area (such as the US map or a particular state) and interacting with the map in order to zoom and pan into the area of interest.

Optionally and in addition to the geographic parameters, a user may choose other parameters such as job growth, income growth, unemployment rate, migration, inventory, value, demand, vacancy, etc. As will be described below, such additional choices offer the consumer the ability to “re-draw” or “re-map” the future value predictions map and thereby present information other than future value predictions.

### Presentation of Statistical Confidence Indicators

Note that by a simple visual inspection of the map on FIG. 3a, a consumer can see which blocks are predicted to have the highest expected appreciation. However, as described above, it is also desirable to show the appropriate level of trust that can be placed in the individual future value predictions, as well as supporting reasons for such trust. We now turn to describing the presentation of statistical confidence indicators for future value predictions to the user.

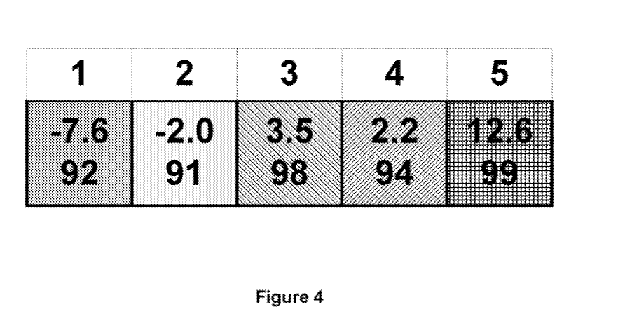

FIG. 4 shows an example presentation of some example future value predictions, along with their respective statistical confidence indicators, following the example data in above Table 1 and in accordance with an embodiment of the present invention. The numbers appearing on top are future value predictions, expressed in expected (forecasted) percentage change of the next quarter over the last quarter. The numbers on the bottom are statistical confidence indicators, expressed in confidence percentages.

In general, the statistical confidence indicators are provided by the data set in use, as described above. As also described above, the data set may indicate different prediction and comparison time periods, such as multiple quarters, etc.

For example, for block group number 060816121004, there is a future value prediction of −7.6% for the next quarter, and the statistical confidence is 92% for the next quarter and 83% for the next 4 quarters (one year). This allows the consumer to determine how much trust to place in each of the presented future value predictions.

### Presentation of Factors Supporting the Future Value Predictions

Having described the presentation of statistical confidence indicators to the user, we now turn to describing the presentation of factors which support the particular future value predictions presented. These are factors which contribute to the future value predictions and can therefore also be interpreted as the “reasons” behind the predictions. The embodiments also disclose the presentation of comparisons of such supporting factors between the blocks or block groups of interest and their vicinity.

To further motivate the presentation of supporting factors, consider block group #1 (block group number 060816121004) as an example. FIG. 4 shows that this block has a large negative future value prediction of −7.6% with a statistical confidence of 92%. Since this block is near block #7 which has a future value prediction of over 15%, it is natural that a consumer may want to see the support or “reasoning” for this prediction. To take this example further, if block #1 happens to be in the same zip code as block #7, their proximity adds to the need for a presentation of supporting factors relating to their diverging future value predictions.

The presentation of supporting factors can be facilitated by allowing the user to interact with the predictions map in order to be presented with one or more supporting factors related to the user selected portions of interest on the map. For example, the user may indicate (such as by right-clicking a mouse or other pointer device) an individual block on the map, resulting in a presentation (such as via a popup window) of information related to the selected block group. As described, such a presentation includes one or more factors supporting the future value prediction of the selected block group, and may optionally comprise a comparison of the presented factors to the surrounding vicinity.

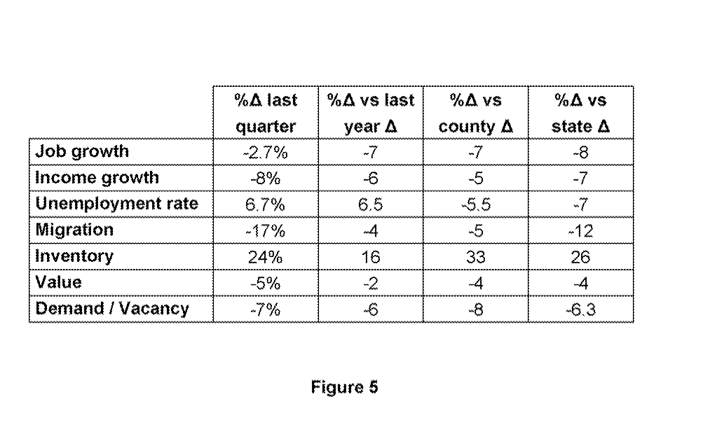

As example of such a presentation is shown in FIG. 5, in accordance with an embodiment of the present invention. Such a presentation may be expanded, upon user request, into a more detailed presentation comprising further details, such as tables and graphs, relating to the presented supporting factors as well as other factors which may not have been initially presented to the user in the interest of brevity and conciseness.

Summarizing the above presentations, note that a user can see a visually marked map (using color gradient or other visual markings) of a chosen geographical region showing block or block group level future value predictions accompanied by associated statistical confidence indicators. The user may further interact with the visual presentation to obtain a summarized or more detailed presentation of factors supporting the presented future value predictions. The visual presentations may depict a small local geographical area or a larger scale geographical region.

### Re-Drawing the Map Based on User Preference

Aside from the initial presentation of a future value predictions map and related statistical confidence indicators and supporting factors, the present invention offers the ability to re-draw (or “re-map”) the visually presented geographical areas to show particular user indicated factors and preferences, either in combination with the future value predictions map or separate from that map. Examples of such factors include:
Job Growth
Income Growth
Unemployment Rate
Migration
Inventory
Value
Demand or Vacancy

### Other example factors were described above.

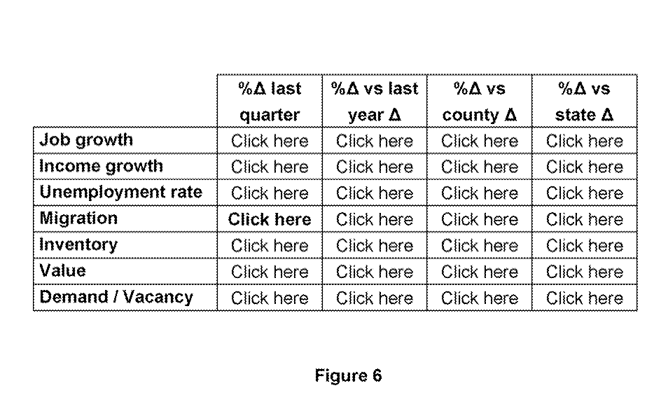

For example, a user may want to see the geographical areas depicted in a future value predictions map re-drawn to show changes in the migration of people for the past quarter. In order to do that, the supporting factors are presented to the user (similar to the example shown in FIG. 5), allowing the user to choose migration factor (or any other factor) as a basis for a re-drawing of the map. An example of such a presentation is shown in FIG. 6, in accordance with an embodiment of the present invention. The presentation shown in FIG. 6 allows a user to click on a particular factor (row) for a particular change period or vicinity comparison (column) and thereby initiate a re-drawing of the map, thereby producing another visual presentation map on which the map markings show changes in the user selected factor. Such maps showing user selected supporting factors are hereinafter also referred to as “re-maps”.

For instance, if the user wants to see a re-map showing migration change of people in the last quarter, the user would click in the “Click here” box shown in bold in the example presentation shown on FIG. 6. As an application example, if a real estate broker has a client interested in buying property in areas with high appreciation and high migration, this re-drawing option allows the broker to produce both maps, one indicating future value predictions and the other indicating migration, and thereby show the client the particular blocks which match the client's investment interest.

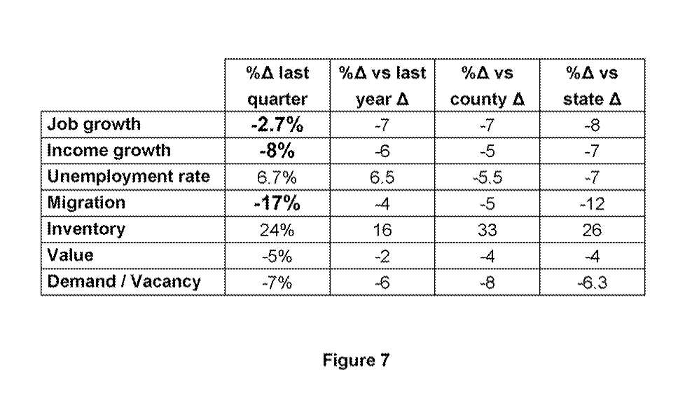

The re-drawing of variables based upon user preferences allows for another type of visual presentation combining the future value predictions map and one or more re-maps showing user selected supporting factors. As an example, consider a consumer who wants to see the future value predictions map along with re-maps drawn based upon job growth, migration, and demand/vacancy. In order to do this, upon presentation of the future value predictions map (for example as shown in FIG. 3a), the user calls up a presentation of the supporting factors (for example as shown in FIG. 5) and then selects the desired factors, such as shown in FIG. 7 in bold and larger fonts, in accordance with an embodiment of the present invention. As a result, the consumer is presented with a map showing future value predictions, as well as three re-maps based on the selected factors, and is thereby enabled to make a calculated decision to buy, invest, move, sell, build, etc. based upon such combined information.

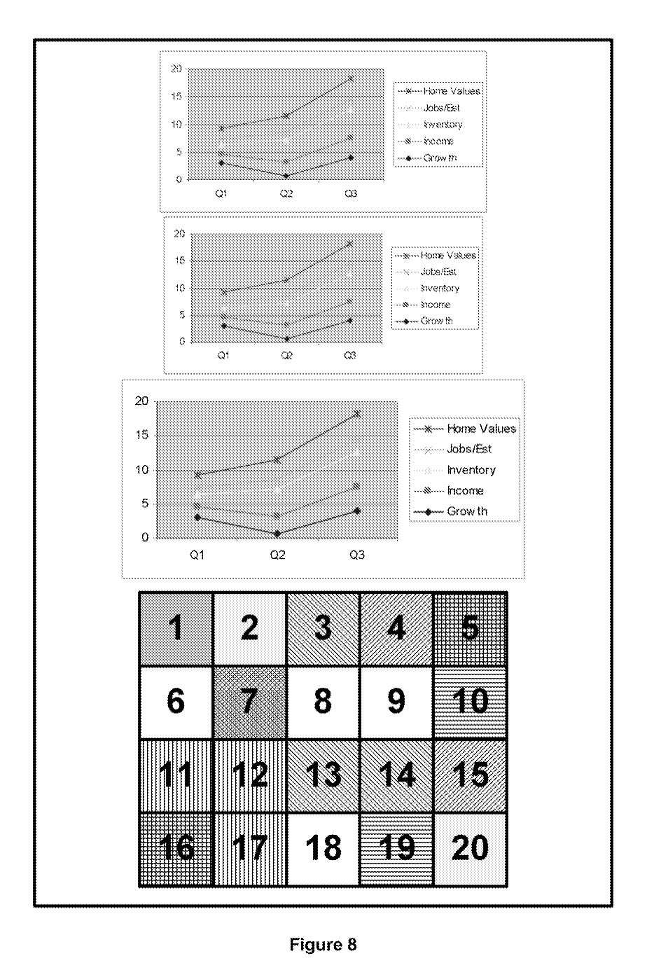

Another application of the future value predictions map and accompanying re-maps as defined or customized by the consumer is the ability to show graphs. Some consumers, such as clients of real estate brokers, may prefer a visual presentation of the future value predictions map along with accompanying graphs depicting one or more supporting factors. This is similar to the previous illustration of the selection of factors, except that the selected factors will be presented using graphs. Taking the previous example of the three factors of job growth, migration, and demand/vacancy chosen by the use for more detailed presentation, FIG. 8 shows one way of visualizing the future value predictions map along with the three user selected factors visualized using graphs, in accordance with an embodiment of the present invention.

### Presentation of Data Other Than Future Value Predictions

It is noted that the various factors described above, such as migration, job growth, etc., can be visually presented on a map as described herein without being necessarily accompanied by a presentation of the future value predictions. Thus, a user may chose to see trends and changes in such factors separately from the presentation of future value predictions and, as should be obvious to one of ordinary skill in the art, the present techniques can be used for that.

### Standalone and Networked Presentations

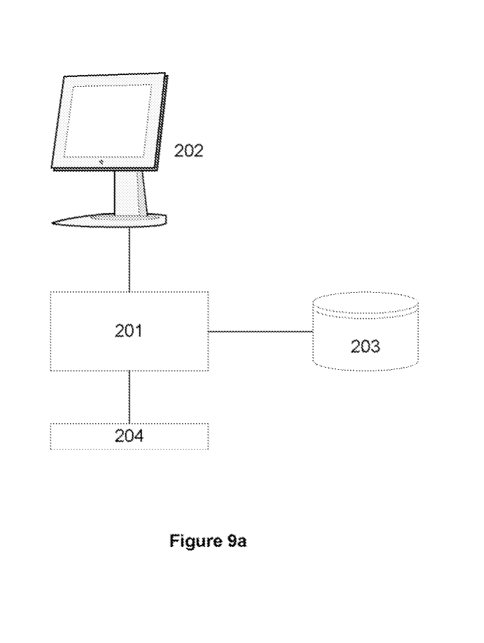

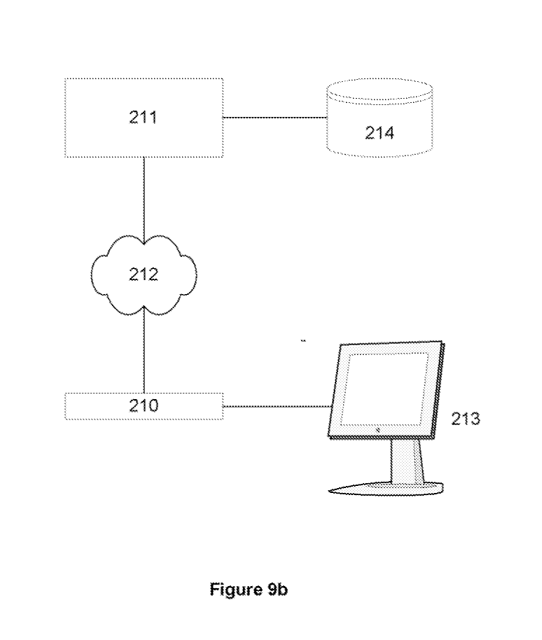

As should be obvious to one of ordinary skill in the art, the visualization and data presentation techniques disclosed herein can be implemented using standard hardware and software platforms in standalone or networked environments. A standalone implementation is shown in FIG. 9a, in accordance with an embodiment of the present invention. A computer or controller 201 is connected to a visual display 202 and performs retrieval of future value predictions data sets from storage element or database 203, performs computations and renderings necessary to generate visualization data, and sends signals to the display 202 for presentation to user. In addition, one ore more input devices 204 such as mouse or keyboard are connected to the computer 201 to facilitate user input. Other standard peripherals may be used to facilitate other input and output and user interactions with the computer 201.

A networked implementation is shown in FIG. 9b, in accordance with an embodiment of the present invention. A user may be a terminal 210 (hereinafter also referred to as a client) and connect to a computer 211 (hereinafter also referred to as a server) over a wired or wireless network 212. The server 211 receives user input from the client 210 over the network 212, performs any retrieval of the needed data sets from storage element or database 214, and performs computations and renderings necessary to generate visualization data. The server 211 sends data back to the client 210 so as to allow rendering of the visual presentations described herein on a visual display 213 connected to the client 210, as well as to communicate with the user in order to receive input selections and facilitate other interactions described herein.

In a networked implementation, the server 211 may allow creation and maintenance of user accounts, authentication mechanisms (such as using logins and passwords) and/or secure communication protocols over network 212 (such as network encryption and/or server side encryption of user data). User accounts can store user preferences, such as frequently used or recently used geographical area selections, categories of supporting factors, periods for future value predictions, vicinities for comparisons, and other features described herein.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure or the scope of the accompanying claims.

1. A method, comprising:
receiving from a user a geographical selection; and
providing to the user a visual presentation of real estate future value predictions for the geographical selection, using a map.

2. A method as recited in claim 1, wherein the visual presentation comprises block level or block group level real estate future value predictions.

3. A method as recited in claim 1, wherein the future value predictions comprise percentage value changes from a period in the past to a period in the future.

4. A method as recited in claim 1, wherein the receiving comprises:
obtaining from the user longitude and latitude coordinates indicating the geographical selection.

5. A method as recited in claim 1, further comprising:
providing a visual presentation of statistical confidence indicators associated with the presented future value predictions.

6. A method as recited in claim 5, further comprising:
receiving from the user a selection of one or more factors supporting the future value predictions; and
providing to the user a visual presentation of the values of the one or more factors for the geographical selection.

7. A method as recited in claim 6, wherein the one or more factors comprise job growth, income growth, unemployment rate, migration, inventory, value, demand or vacancy.

8. A system, comprising:
a visual display; and
a controller, the controller for:
receiving from a user a geographical selection; and
displaying on the visual display a presentation of real estate future value predictions for the geographical selection, using a map.

9. A system as recited in claim 8, wherein the visual presentation comprises block level or block group level real estate future value predictions.

10. A system as recited in claim 8, wherein the future value predictions comprise percentage value changes from a period in the past to a period in the future.

11. A system as recited in claim 8, wherein the receiving comprises:
obtaining from the user longitude and latitude coordinates indicating the geographical selection.

12. A system as recited in claim 8, the controller further for:
displaying on the visual display a presentation of statistical confidence indicators associated with the presented future value predictions.

13. A system as recited in claim 12, the controller further for:
receiving from the user a selection of one or more factors supporting the future value predictions; and
displaying on the visual display a presentation of the values of the one or more factors for the geographical selection.

14. A system as recited in claim 13, wherein the one or more factors comprise job growth, income growth, unemployment rate, migration, inventory, value, demand or vacancy.

15. A method, comprising:
receiving from a user a login and password sent over a network via a terminal;
retrieving from a database a set of preferences for the user, the set of preferences pertaining to real estate future value predictions for a geographical selection; and
sending to the terminal a set of data for visual rendering by the terminal, the set of data comprising a visual presentation of the real estate future value predictions for the geographical selections, using a map.

16. A method as recited in claim 1, wherein the visual presentation comprises block level or block group level real estate future value predictions.

17. A method as recited in claim 15, wherein the set of data further comprises a visual presentation of statistical confidence indicators associated with the future value predictions.

18. A method as recited in claim 16, wherein the set of preferences further pertains to one or more factors supporting the future value predictions.

19. A method as recited in claim 18, wherein the one or more factors comprise job growth, income growth, unemployment rate, migration, inventory, value, demand or vacancy.

20. A computer-readable medium having computer-executable instructions for performing the steps of:
receiving from a user a geographical selection; and
providing to the user a visual presentation of real estate future value predictions for the geographical selection, using a map.
